(19) United States
(12) Patent Application Publication
(10) Pub. No.: US 2012/0327103 A1
(43) Pub. Date: Dec. 27, 2012

(54) ELECTRONIC DEVICE AND METHOD FOR PROCESSING IMAGE USING THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/427,887

(22) Filed: Mar. 23, 2012

(30) Foreign Application Priority Data
Jun. 23, 2011 (TW) 100121923

(51) Int. Cl. G09G 5/02

(52) U.S. Cl. 345/593; 345/589

(57) ABSTRACT

In a method for processing images using an electronic device, a plurality of images captured at a specific time is obtained from a storage device of the electronic device. The method obtains red, green, and blue (RGB) values of a first pixel of each obtained images, selects a specific quantity of red values, green values, and blue values of the first pixel from the obtained RGB values. The method further obtains optimized RGB values for the first pixel by calculating average values of the selected red values, green values, and blue values respectively, calculates optimized RGB values for remaining pixels of the obtained images, creates an optimized image based on all of the optimized RGB values, and displays the optimized image on a display device of the electronic device.

### BACKGROUND

1. Technical Field

Embodiments of the present disclosure relate to image processing technology, and particularly to an electronic device and method for processing images captured at one time by a plurality of lens modules of the electronic device.

2. Description of Related Art

Image capturing devices (e.g., closed circuit television (CCTV)) may include a plurality of lenses to perform security surveillance by capturing a plurality of images of a specific scenes at the same time, sending the plurality of images to a surveillance monitoring computer, and storing the images captured at different times in a storage device. However, when a user has to select an optimized image (i.e., an image with the highest definition) manually from all the simultaneously-captured images, it is inconvenient and time consuming. Therefore, a more efficient method for processing images is desired.

### BRIEF DESCRIPTION OF THE DRAWINGS

FIG. 1 is a block diagram of one embodiment of an electronic device including an image processing system.

FIG. 2 is a block diagram of function modules of the image processing system included in the electronic device.

FIG. 3 is a flowchart of one embodiment of a method for processing images using the electronic device.

FIG. 4 is an example of one embodiment of RGB values of a first pixel of ten images.

FIG. 5 is an example of a specific quantity of red values selected from the images in FIG. 4.

FIG. 6A is an example of calculating a mean difference between the red values of the first pixel of a first image “P1” as shown in FIG. 4.

FIG. 6B is an example of calculating a mean difference between the red values of the first pixel of a fifth image “P5” as shown in FIG. 4.

FIG. 7A is an example of calculating an average value of the selected red values of the first pixel of the ten images in FIG. 4.

FIG. 7B is an example of calculating an average value of the selected green values of the first pixel of the ten images in FIG. 4.

FIG. 7C is an example of calculating an average value of the selected blue values of the first pixel of the ten images in FIG. 4.

FIG. 8 is a schematic diagram of one embodiment of iterated calculations for optimizing RGB values of each of residual pixels of the ten images in FIG. 4.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

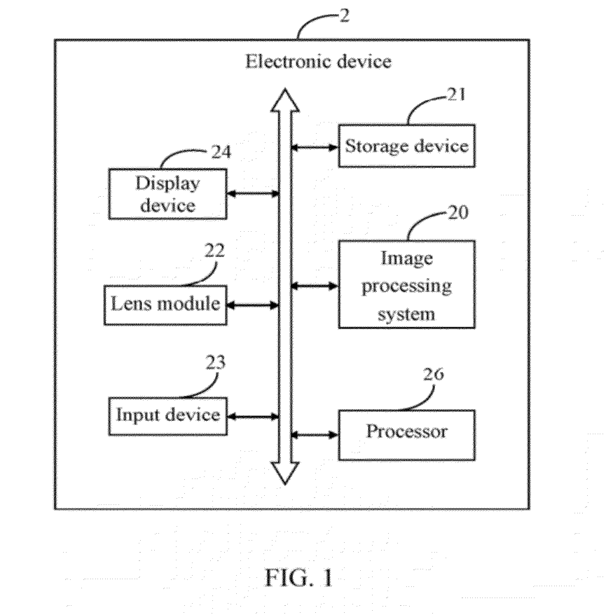

FIG. 1 is a block diagram of one embodiment of an electronic device 2 including an image processing system 20. The electronic device 2 further includes a storage device 21, one or more lens modules 22 (only one is shown in FIG. 1), an input device 23, a display device 24, and at least one processor 26. The electronic device 2 may be an image capturing device (e.g., a multi-sensor camera), the lens modules 22 may be a plurality of charge coupled device (CCD) sensors. FIG. 1 illustrates only one example of the electronic device 2 that may include more or fewer components than as illustrated, and/or have a different configuration of the various components in other embodiments.

The input device 23 may be a keyboard, a touch screen, and/or a touchpad used to input digital data, and the display device 24 may be a liquid crystal display (LCD) or other suitable display.

The image processing system 20 is used to process a plurality of images captured at one particular time to automatically obtain one optimized image, and store the optimized image into the storage device 21. In one embodiment, the image processing system 20 may include computerized instructions in the form of one or more programs that are executed by the at least one processor 26 and stored in the storage device 21 (or other memory). A detailed description of the image processing system 20 will be given.

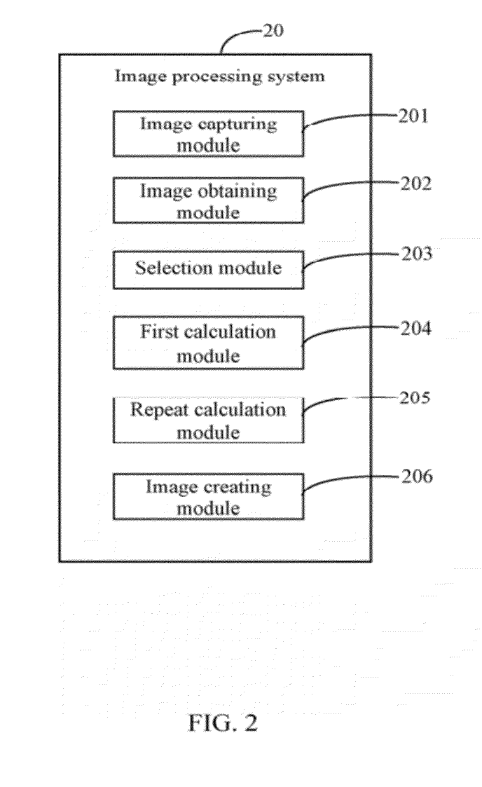

FIG. 2 is a block diagram of function modules of the image processing system 20 included in the electronic device 2. In one embodiment, the image processing system 20 may include one or more modules, for example, an image capturing module 201, an image obtaining module 202, a selection module 203, a first calculation module 204, a repeat calculation module 205, and an image creating module 206. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

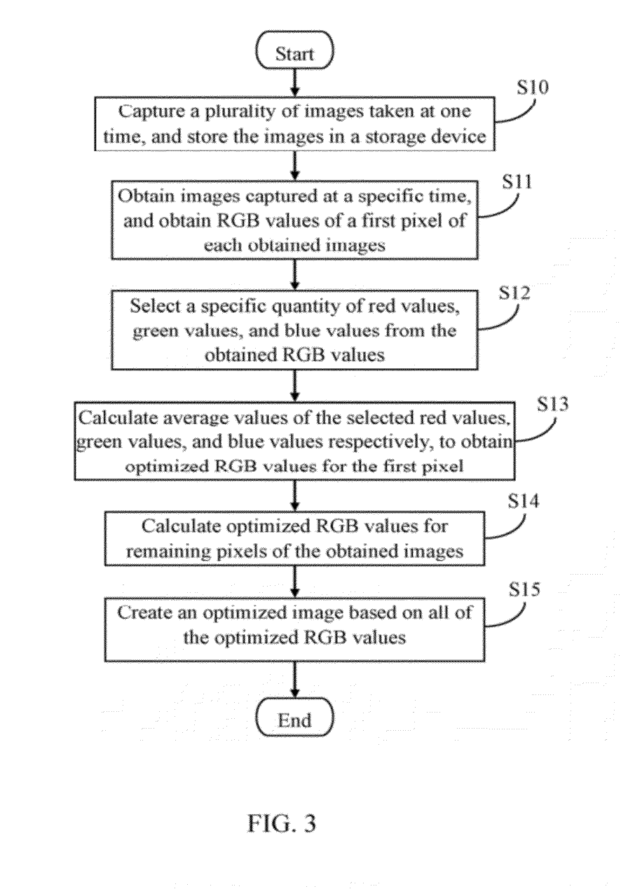

FIG. 3 is a flowchart of one embodiment of a method for processing images using the electronic device 2 of FIG. 1. Depending on the embodiment, additional blocks may be added, others removed, and the ordering of the blocks may be changed.

In block S10, the image capturing module 201 captures a plurality of images taken at one time (i.e., at the same time) by the lens modules 22, and stores all captured images into the storage device 21. In one embodiment, each of the lens modules 22 captures images at the same view of a specified scene.

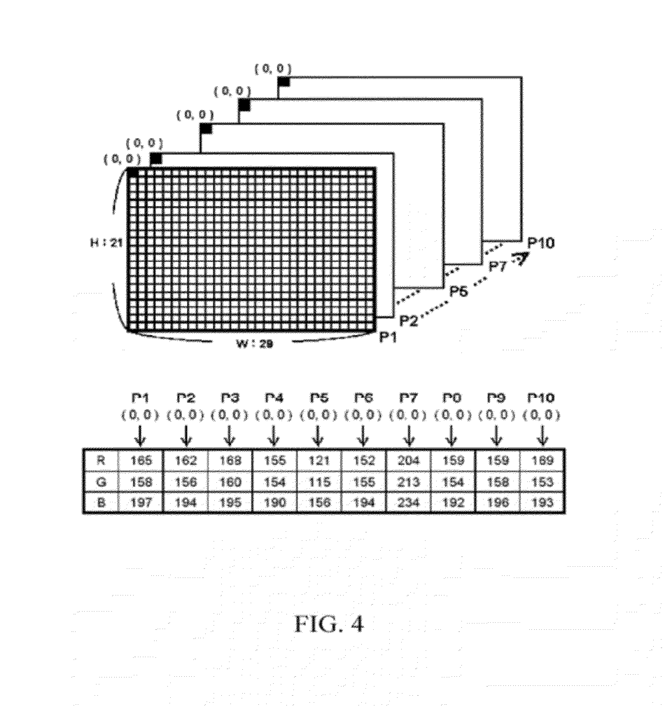

In block S11, the image obtaining module 202 obtains a plurality of images captured at a specific time (e.g., 9:00 A.M.) from the storage device 21, and obtains red, green, and blue (RGB) values of a first pixel of each obtained images. Referring to FIG. 4, suppose that ten images, such as P1 to P10, are obtained. The designation “(0, 0)” represents coordinates of the first pixel of the ten images, “R” represents the red value of the first pixel, “G” represents the green value of the first pixel, and “B” represents the blue value of the first pixel.

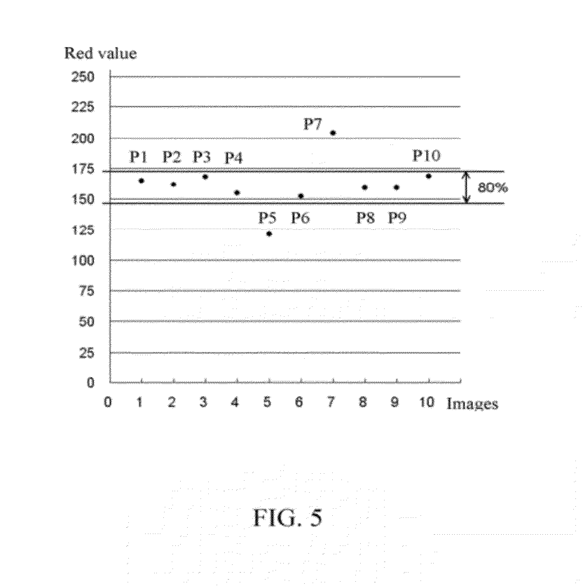

In block S12, the selection module 203 selects a specific quantity of red values, green values, and blue values of the first pixel from the obtained RGB values. In one embodiment, the specific quantity is predetermined by a user. For example, the specific quantity is represented by a percentage, such as 80%. As shown in FIG. 5, the selection module 203 selects, from eight images, eight pixels having minimal differences, such as P1, P2, P3, P4, P6, P8, P9, and P10. The first pixels of images P5 and P7 are thus omitted. An example of how to select the specific quantity of the red values of the first pixel from the obtained RGB values is as follows.

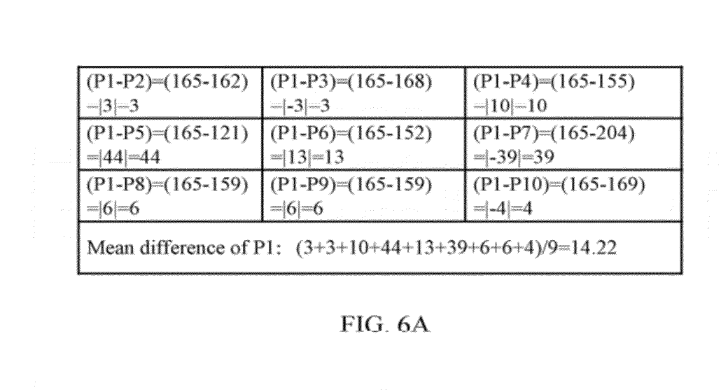

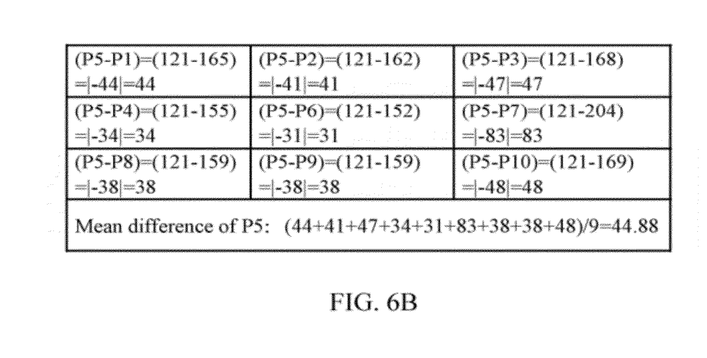

First, the selection module 203 calculates any difference between the red values for the first pixel of each one of the obtained images and the remaining obtained images, and obtains an absolute value of each calculated difference. For example, as shown in FIG. 6A, the differences between the red values for the first pixel of the first image “P1” and the remaining images (i.e., P2 to P10) are as follows: P1-P2, P1-P3, P1-P4, P1-P5, P1-P6, P1-P7, P1-P8, P1-P9, and P1-P10. As shown in FIG. 6B, the differences between the red values for the first pixel of the fifth image “P5” and the remaining images (i.e., P1-P4 and P6-P10) are as follows: P5-P1, P5-P2, P5-P3, P5-P4, P5-P6, P5-P7, P5-P8, P5-P9, and P5-P10.

Second, the selection module 203 calculates an average value of all of the absolute values of the calculated differences, to obtain a mean difference for the red value in relation to the first pixel of each obtained image. For example, an example of calculating a mean difference for the red value in the first pixel of the first image P1 is shown in FIG. 6A. The mean difference for the red value in the first pixel of “P1” is equal to (3+3+10+44+13+39+6+6+4)/9=14.22. Another example of calculating a mean difference for the red value in the first pixel of the fifth image P5 is shown in FIG. 6B. The mean difference for the red value in the first pixel of “P5” is equal to (44+41+47+34+31+83+38+38+48)/9=44.88.

Third, the selection module 203 selects the specific quantity of the red values of the first pixel from the mean difference according to an ascending order. In one embodiment, the ascending order is determined from the smallest mean difference up to the largest mean difference. For example, suppose that a sequence of the mean difference of the ten images according to the ascending order is as follows: P9, P8, P2, P1, P4, P6, P3, P10, P5, P7. Thus, the eight red values (i.e., 80%) of the first pixel are selected from the images of P9, P8, P2, P1, P4, P6, P3, P10, then the remaining red values (i.e., 20%) of the last two images of P5 and P7 are omitted.

In one embodiment, the selection module 203 selects the specific quantity of green values and blue values of the first pixel from the obtained RGB values using a method similar to that described above.

In block S13, the first calculation module 204 calculates average values of the selected red values, green values, and blue values respectively, and obtains a round number of each of the calculated average values. The round numbers of the calculated average values are regarded as optimized RGB values of the first pixel in each of the obtained ten images.

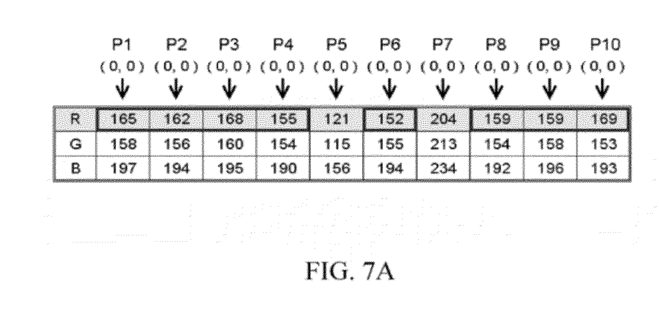

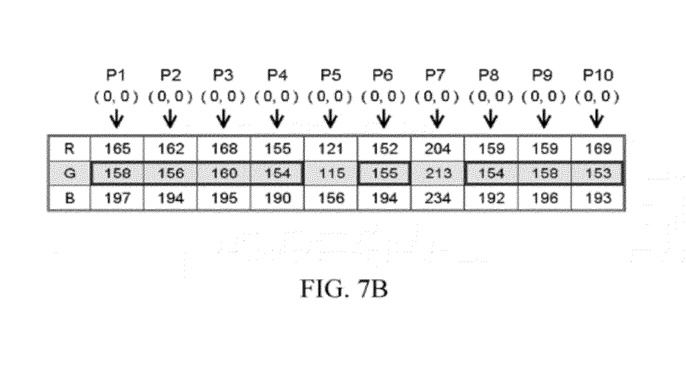

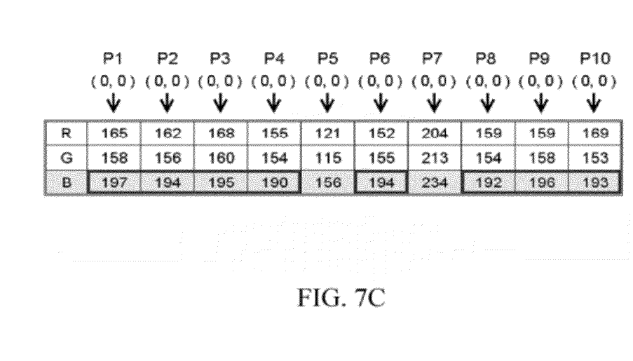

An example of calculating an average value of the selected red values of the first pixel of the ten images is shown in FIG. 7A. As described above, the selected red values are images of P1, P2, P3, P4, P6, P8, P9, and P10. Thus, the average value of the selected red values of the first pixel is equal to round number ((165+162+168+155+152+159+159+169)/8=161), where “round number ( )” represents a function to obtain a round number for the calculated average value.

An example of calculating an average value of the selected green values of the first pixel of the ten images is shown in FIG. 7B. The average value of the selected green values of the first pixel is equal to round number ((158+156+160+154+155+154+158+153)/8=156).

An example of calculating an average value of the selected blue values of the first pixel of the ten images is shown in FIG. 7C. The average value of the selected blue values of the first pixel is equal to round number ((197+194+195+190+194+192+196+193)/8=194). Thus, the respective optimized RGB values of the first pixel in the obtained ten images are defined as (161, 156, 194).

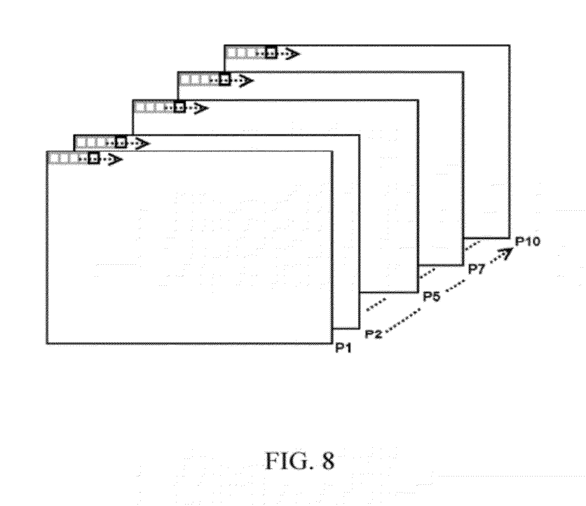

In block S14, the repeat calculation module 205 calculates optimized RGB values for each of the remaining pixels (e.g., the second pixel, the third pixel, and so on) of the obtained images using the above-mentioned method (refers to FIG. 8).

In block S15, the image creating module 206 creates an optimized image based on all of the optimized RGB values, and displays the optimized image on the display device 24. For example, the respective RGB values for the first pixel in the optimized image are (161, 156, 194) as obtained in block S13.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for processing images using an electronic device, the method comprising:
obtaining a plurality of images captured at a specific time from a storage device of the electronic device;
obtaining red, green, and blue (RGB) values of a first pixel of each of the obtained images;
selecting a specific quantity of red values, green values, and blue values of the first pixel from the obtained RGB values;
obtaining optimized RGB values for the first pixel by calculating average values of the selected red values, green values, and blue values respectively;
calculating optimized RGB values for remaining pixels of the obtained images; and
creating an optimized image based on all of the optimized RGB values, and displaying the optimized image on a display device of the electronic device.

2. The method according to claim 1, wherein the specific quantity of red values of the first pixel are selected from the obtained RGB values by:
calculating any difference between the red values for the first pixel of each one of the obtained images and the remaining obtained images, and obtaining an absolute value of each calculated difference;
obtaining a mean difference for the red value in the first pixel of each obtained image by calculating an average value of all of the absolute values; and
selecting the specific quantity of the red values of the first pixel from the mean difference according to an ascending order.

3. The method according to claim 1, wherein the specific quantity of green values of the first pixel are selected from the obtained RGB values by:
calculating any difference between the green values for the first pixel of each one of the obtained images and the remaining obtained images, and obtaining an absolute value of each calculated difference;
obtaining a mean difference for the green value in the first pixel of each obtained image by calculating an average value of all of the absolute values; and
selecting the specific quantity of the green values of the first pixel from the mean difference according to an ascending order.

4. The method according to claim 1, wherein the specific quantity of blue values of the first pixel are selected from the obtained RGB values by:
calculating any difference between the blue values for the first pixel of each one of the obtained images and the remaining obtained images, and obtaining an absolute value of each calculated difference;
obtaining a mean difference for the blue value in the first pixel of each obtained image by calculating an average value of all of the absolute values; and
selecting the specific quantity of the blue values of the first pixel from the mean difference according to an ascending order.

5. The method according to claim 1, wherein the specific quantity is represented with a percentage.

6. The method according to claim 1, further comprising: storing the optimized image into the storage device.

7. An electronic device, comprising:
a storage device;
at least one processor; and
one or more modules that are stored in the storage device and executed by the at least one processor, the one or more modules comprising:
an image obtaining module that obtains a plurality of images captured at a specific time from the storage device;
a selection module that obtains red, green, and blue (RGB) values of a first pixel of each of the obtained images, and selects a specific quantity of red values, green values, and blue values of the first pixel from the obtained RGB values;
a first calculation module that obtains optimized RGB values for the first pixel by calculating average values of the selected red values, green values, and blue values respectively;
a repeat calculation module that calculates optimized RGB values for remaining pixels of the obtained images; and
an image creating module that creates an optimized image based on all of the optimized RGB values, and displays the optimized image on a display device of the electronic device.

8. The electronic device according to claim 7, wherein the selection module selects the specific quantity of red values of the first pixel by:
calculating any difference between the red values for the first pixel of each one of the obtained images and the remaining obtained images, and obtaining an absolute value of each calculated difference;
obtaining a mean difference for the red value in the first pixel of each obtained image by calculating an average value of all of the absolute values; and
selecting the specific quantity of the red values of the first pixel from the mean difference according to an ascending order.

9. The electronic device according to claim 7, wherein the selection module selects the specific quantity of green values of the first pixel by:
calculating any difference between the green values for the first pixel of each one of the obtained images and the remaining obtained images, and obtaining an absolute value of each calculated difference;
obtaining a mean difference for the green value in the first pixel of each obtained image by calculating an average value of all of the absolute values; and
selecting the specific quantity of the green values of the first pixel from the mean difference according to an ascending order.

10. The electronic device according to claim 7, wherein the selection module selects the specific quantity of blue values of the first pixel by:
calculating any difference between the blue values for the first pixel of each one of the obtained images and the remaining obtained images, and obtaining an absolute value of each calculated difference;
obtaining a mean difference for the blue value in the first pixel of each obtained image by calculating an average value of all of the absolute values; and
selecting the specific quantity of the blue values of the first pixel from the mean difference according to an ascending order.

11. The electronic device according to claim 7, wherein the specific quantity is represented with a percentage.

12. The electronic device according to claim 7, wherein the image creating module further stores the optimized image into the storage device.

13. A non-transitory storage medium having stored thereon instructions that, when executed by a processor of an electronic device, causes the electronic device to perform a method for processing images, the method comprising:
obtaining a plurality of images captured at a specific time from a storage device of the electronic device;
obtaining red, green, and blue (RGB) values of a first pixel of each of the obtained images;
selecting a specific quantity of red values, green values, and blue values of the first pixel from the obtained RGB values;
obtaining optimized RGB values for the first pixel by calculating average values of the selected red values, green values, and blue values respectively;
calculating optimized RGB values for remaining pixels of the obtained images; and
creating an optimized image based on all of the optimized RGB values, and displaying the optimized image on a display device of the electronic device.

14. The non-transitory storage medium according to claim 13, wherein the specific quantity of red values of the first pixel is selected from the obtained RGB values by:
calculating any difference between the red values for the first pixel of each one of the obtained images and the remaining obtained images, and obtaining an absolute value of each calculated difference;
obtaining a mean difference for the red value in the first pixel of each obtained image by calculating an average value of all of the absolute values; and
selecting the specific quantity of the red values of the first pixel from the mean difference according to an ascending order.

15. The non-transitory storage medium according to claim 13, wherein the specific quantity of green values of the first pixel is selected from the obtained RGB values by:
calculating any difference between the green values for the first pixel of each one of the obtained images and the remaining obtained images, and obtaining an absolute value of each calculated difference;
obtaining a mean difference for the green value in the first pixel of each obtained image by calculating an average value of all of the absolute values; and
selecting the specific quantity of the green values of the first pixel from the mean difference according to an ascending order.

16. The non-transitory storage medium according to claim 13, wherein the specific quantity of blue values of the first pixel is selected from the obtained RGB values by:
calculating any difference between the blue values for the first pixel of each one of the obtained images and the remaining obtained images, and obtaining an absolute value of each calculated difference;
obtaining a mean difference for the blue value in the first pixel of each obtained image by calculating an average value of all of the absolute values; and
selecting the specific quantity of the blue values of the first pixel from the mean difference according to an ascending order.

17. The non-transitory storage medium according to claim 13, wherein the specific quantity is represented with a percentage.

18. The non-transitory storage medium according to claim 13, wherein the method further comprises: storing the optimized image into the storage device.

19. The non-transitory storage medium according to claim 13, wherein the medium is selected from the group consisting of a hard disk drive, a compact disc, a digital video disc, and a tape drive.
